(19) United States
(12) Patent Application Publication
(10) Pub. No.: US 2017/0315958 A1
(43) Pub. Date: Nov. 2, 2017

(54) COMPUTER-IMPLEMENTED METHOD FOR SOLVING SETS OF LINEAR ARITHMETIC CONSTRAINTS MODELLING PHYSICAL SYSTEMS

(71) Applicant: BARCELOGIC SOLUTIONS S.L., Barcelona (ES)

(72) Inventor: Robert L. M. Nieuwenhuis, Barcelona (ES)

(21) Appl. No.: 15/651,122

(22) Filed: Jul. 17, 2017

Related U.S. Application Data
(63) Continuation-in-part of application No. 14/192,909, filed on Feb. 28, 2014.

(51) Int. Cl. G06F 17/12; G06F 17/10

(52) U.S. Cl. CPC G06F 17/12; G06F 17/10

(57) ABSTRACT

A computer-implemented method for solving sets of linear arithmetic constraints modelling physical systems by programmed execution of mathematical operations in a processor unit, wherein the programmed execution of mathematical operations decide, given a set of constraints S, whether S has any solution, and if so, find one or more of them.

### CROSS REFERENCE TO RELATED APPLICATIONS

This application is a Continuation-in-Part of U.S. patent application Ser. No. 14/192,909, filed Feb. 28, 2014, the contents of such application being incorporated by reference herein.

### FIELD OF THE INVENTION

The invention relates to data processing generally, and more particularly, to data processing under the guidance of a computer implemented method for search-based integer linear programming (ILP), involving the programmed execution of mathematical operations in a processor unit for deciding, given a set of constraints S, whether S has any solution, and if so, finding one or more of them.

### Definitions

Along this description following notions/terms will be used:
A constraint over a finite set of variables, X {x₁ . . . xₙ} is an expression of the form a₁x₁+ . . . +aₙxₙ≦a₀, in which the coefficients a₀ . . . aₙ are integer numbers.
A solution for a set S of constraints or integer program (IP) over {x₁ . . . xₙ} is a function Sol mapping each variable x of {x₁ . . . xₙ} to an integer value Sol(x) such that all constraints are satisfied, that is, for each constraint of the form a₁x₁+ . . . +aₙxₙ≦a₀, the integer number a₁.Sol(x₁)+ . . . +aₙ·Sol(xₙ) is smaller than or equal to a₀.
Optimization: maximizing (or minimizing) an objective function (or a cost function), an expression of the form a₁x₁+ . . . +aₙxₙ, that is, finding a solution Sol such that a₁.Sol(x₁)+ . . . +aₙ·Sol(xₙ) is maximized (minimized).
MIP: Solving Mixed IPs (MIPs): finding solutions where some variables must take integer values and others can be arbitrary rationales.
A lower bound for a variable x is an expression of the form a≦x, where a is an integer number, and an upper bound for a variable x is an expression of the form x≦a, where a is an integer number and a bound is an expression that is either a lower bound or an upper bound.
The negation of a lower bound a≦x is the upper bound x≦a−1 and the negation of an upper bound x≦a is the lower bound a+1≦x.
A lower bound a₁≦x and an upper bound x≦a₂ are called conflicting if a₁>a₂.
A lower bound a≦x is called new in a given set of bounds B if there is no lower bound a′≦x in B with a′≧a, and an upper bound x≦a is called new in a given set of bounds B if there is no upper bound x≦a′ in B with a′≦a, and a variable x is called defined to the value a in a given set of bounds B, if B contains the bounds a≦x, and x≦a.
A monomial is an expression of the form a x, where a is an integer or a rational number and x is a variable. It is called negative if a is negative and positive otherwise.
Propagation:
If C is a linear arithmetic constraint of the form a₁x₁+ . . . +aₙxₙ≦a₀ where:
   the subset of positive monomials of {a₁x₁, . . . , aₙxₙ} is {ax, c₁y₁, . . . , cₚyₚ};
   the subset of negative monomials of {a₁x₁ . . . aₙxₙ} is {d₁z₁, . . . , d_{q}z_{q}};
   R is a set of bounds {l₁≦y₁, . . . , lₚ≦yₚ, z₁≦u₁, . . . , z_{q}≦u_{q}};
   u is the largest integer such that u≦(a₀−c₁l₁− . . . −cₚlₚ−d₁u₁− . . . −d_{q}u_{q})/a, then C and R propagate the upper bound x≦u.
For example, if C is 2x+3y+3z≦13 and R is {1≦x, 2≦y} then C and R propagate z≦1, since 1 is the largest integer u such that u≦(13−2·1−3·2)/3=(13−8)/3=5/3.
For example, if C is 2x≦13 and R is the empty set, then C and R propagate x≦6, since 6 is the largest integer u such that u≦13/2.
If C is a linear arithmetic constraint of the form a₁x₁+ . . . +aₙxₙ≦a₀ where:
   the subset of positive monomials of {a₁x₁, . . . , aₙxₙ} is {c₁y₁, . . . , cₚyₚ};
   the subset of negative monomials of {a₁x₁, . . . , aₙxₙ} is {ax, d₁z₁, . . . , d_{q}z_{q}};
   R is a set of bounds {l₁≦y₁, . . . , lₚ≦yₚ, z₁≦u₁, . . . , z_{q}≦U_{q}};
   l is the smallest integer such that l≧(a₀−c₁l₁− . . . −cₚlₚ−d₁u₁− . . . −d_{q}u_{q})/a, then C and R propagate the lower bound l≦x.
For example, if C is 2x+3y−3z≦13 and R is {1≦x, 2≦y} then C and R propagate −1≦z, since −1 is the smallest integer l such that l≧(13−2·1−3·2)/−3=(13−8)/−3=−5/3.
   Conflicting Subset or CSS, is a data structure storing a set of bounds.
   Conflicting constraint or CC, is a data structure storing a linear arithmetic constraint.
   Cut
   If C₁ is a linear arithmetic constraint a₁x₁+ . . . +aₙxₙ≦a₀ and C₂ is a linear arithmetic constraint b₁x₁+ . . . +bₙxₙ≦b₀, then a cut between C₁ and C₂ is a linear arithmetic constraint c₁x₁+ . . . +cₙxₙ≦c₀ such that c and d are positive natural numbers and cᵢ=c·aᵢ+d·bᵢ for each i in 0 . . . n; and
   If cⱼ=0 for some j in 1 . . . n then this cut is said to eliminate the variable xⱼ.
Learning a constraint
   a propagation record is a triple (b, R, C) where b is a bound C is a linear arithmetic constraint and R is a set of bounds such that C and R propagate b, then R being termed the reason set of b and C being termed the reason constraint of b; in a special kind of propagation record called a decision, the components R and C are null,
   a propagation stack is a data structure having capabilities of a standard stack data structure whose elements are propagation records, with standard operations for pushing and popping elements and for inspecting the topmost element and in addition the nonstandard capability of inspecting non-topmost elements;
   a bound b is said to be in a propagation stack B if b is the first element of some propagation record of B; similarly a set of bounds R is said to be in a propagation stack B if R is a subset of the set of all first elements of the propagation records of B,
a constraint C is said to be learned when it is added to the set of linear arithmetic constraints S.

### BACKGROUND OF THE INVENTION

Efficient ILP is crucial for many applications. For example, to find a feasible or optimal schedule in a limited period of time for a set of industrial tasks, where each task has a given duration and requires certain amounts of different limited resources (machines, trucks, employees). ILP (as well as SAT, see below) is NP-complete: no efficient (polynomial) algorithm for it has been found and the existence of such a polynomial algorithm is considered unlikely.

The use of computer implemented ILP methods, models or algorithms for automatically solving with the aid of a processor unit, different integer problems expressed in the form of a set S of constraints appears disclosed in the following patents U.S. Pat. No. 7,653,561, U.S. Pat. No. 8,515,280, U.S. Pat. No. 8,402,396 and patent applications US 2011/0153709 and US 2012/0250500 addressing different technical fields.

Just about any discrete optimization problem is an IP or a MIP: scheduling, routing, planning, configuration, timetabling, etc.

One concrete physical application is the ‘knapsack’ problem that is following detailed.

For instance, a truck will be going from A to B. There are n different types of items {1 . . . n} to be carried, where each type of item i has aᵢ units available, and each unit of it weights wᵢ kg and brings a profit of pᵢ per carried unit.

The problem is to decide how many units xᵢ of each item type i to carry, without exceeding the truck's total capacity of K kg, in order to make a total profit of at least P$: the IP will consist of w₁xᵢ+ . . . +wₙxₙ≦K and p₁x₁+ . . . +pₙ xₙ≧P, with initial bounds 0≦x≦a.

The corresponding optimization problem is, instead of requiring the total profit p₁x₁+ . . . +pₙxₙ to be at least P $, to maximize it.

There are numerous extensions of this problem, such as further constraints on, e.g., a maximal total number of units carried of certain subclasses of items, more than one truck, etc.

Most current ILP methods work by iteratively solving LP relaxations, i.e., first finding rational (possibly non-integer) solutions for the set of constraints. Additional steps are then performed to progressively turn these solutions into an integer one, for example by cutting-plane or Branch-and-cut methods.

The method described in this patent application performs no LP relaxations. It does a systematic search over the set of possible integer solutions. It borrows ideas from SAT solving, which can be seen as the special case of ILP where the variables x₁ . . . xₙ can only take the values 0 or 1 (as in 0/1 integer programming) and where constraints are of the form 1·x₁+ . . . +1·xₘ−1·y₁− . . . −1·yₙ≦m−1, expressed as clauses {x̅₁, . . . , x̅ₘ, y₁, . . . , yₙ} i.e., sets (disjunctions) of literals, where a literal is a either variable x or a negated variable x̅.

A basic SAT solving method is DPLL [1, 2] which comprises the following steps maintaining a partial assignment A, written here as a stack of literals that grows to the right:
1. start with an empty partial assignment A
2. propagate while possible: extend A to A l if there is some clause {l}∪C with all its variables assigned in A except the one of l, and A∩C=
3. if there is some conflict, a clause C with all variables assigned and A∩C=, then go to step 6
4. if all variables are assigned and there is no conflict, halt with solution A
5. decide: take some unassigned variable x and extend A to A x or to A x̅; here the literal x or x̅ is called a decision
6. backtrack: if there is some conflict and A is of the form A₁ l A₂, where l is the rightmost decision in A, then replace A by A₁ l̅ (where l̅ is not a decision)
7. if there is some conflict and A contains no decisions, then halt with output ‘no solution’
8. go to step 2.

It is rather obvious that this procedure performs an exhaustive systematic search over all possible assignments. The key issues are its efficient implementation, that is, a) data structures and b) heuristics for guiding the search: which variables to decide on first and how to prune the search space.

Indeed, modern extensions of the DPLL method include efficient data structures for propagation as disclosed in U.S. Pat. No. 7,418,369 and for clause learning, at each conflict, a new clause C can be added (learned), such that instead of backtrack one can do a backjump step, replacing A₁ l A₂ by A₁ l′ where C propagates l′ from A₁. A single backjump step can undo several decisions as l needs not be the rightmost decision in A.

Pioneering work on clause learning was given by Marques-Silva and Sakallah in [3]. Analysis of the most frequently used learning scheme, the 1-UIP one, was done by Moskewicz, et. al. [4]. Propagations by 1-UIP learned clauses prune the search space very effectively. Such SAT-solving techniques are nowadays called conflict-driven clause learning (CDCL).

There have been several attempts to carry over CDCL from SAT to ILP. Then, clauses become constraints, literals become bounds (constraints with a single variable, that can be written as lower bounds a≦x or upper bounds x≦a), and propagation becomes bound propagation.

An important problem for applying CDCL in ILP is the following rounding problem. Assume having the two constraints 1x+5y≦5 and 1x−5y≦0 and taking the decision 1≦x. Then from the first constraint y≦4/5, can be inferred, which is rounded, causing a bound propagation of the new bound y≦0, which, together with 1≦x causes a conflict with the second constraint. Now a cut inference, eliminating y generates the new learned 1-UIP constraint 2x≦5. But unfortunately, unlike what happens in SAT, it is too weak to force a backjump. This problem is due to the rounding that takes place when propagating y.

In [5] the rounding problem is solved by limiting the kind of decisions that are allowed. This makes it possible, at each conflict caused by propagations with rounding, to compute so-called tightly propagating constraints that justify the same propagations without rounding. Drawbacks for performance are the complexity of computing the tightly propagating constraints, the limited kind of decisions and that the learned constraints are very different from the 1-UIP ones.

This invention proposes another method to overcome the rounding problem. It permits arbitrary decisions and guide the search analogously to the 1-UIP approach in SAT. Consider again the two constraints C₁: 1x+5y≦5 and C₂: 1x−5y≦0. After taking the decision 1≦x, the constraint C₂ propagates 1≦y and C₁ propagates y≦0 (obtaining a conflicting pair of bounds). Now along with each propagated bound, it is not only remembered which constraint caused its propagation, but also the set of bounds that caused it. For example, the bound y≦0 has the associated reason set {1≦x} and reason constraint C₁. Similarly, along with 1≦y the reason constraint C₂ and the reason set {1≦x} is stored. If a conflicting pair of bounds appears, a conflict analysis is done.

First, the conflicting pair is stored in the so called CSS (here, {1≦y, y≦0}). Along the process this CSS always contains a set of bounds that is inconsistent together with the constraints. Similarly to the CDCL SAT solvers' conflict analysis (but with bounds instead of literals) in the CSS the most recently propagated bound it is repeatedly replaced by its reason set. Here, after the first step, the CSS becomes {1≦x, y≦0}. After a finite number of such replacements, one always reaches a CSS that justifies a backjump. Here, after the second replacement (replacing y≦0 by 1≦x), the CSS becomes {1≦x}, inferring that 1≦x alone is also conflicting, so one can backjump to before the first decision and assert the negation of 1≦x, that is, x≦0. In our method this conflict analysis process in addition guides a sequence of cut inferences between the reason constraints of the bounds that are being replaced, and the finally resulting constraint can be learned. This backjumping method can always be applied, even if the learned constraint obtained using the cuts is too weak, due to the rounding problem, to justify this backjump.

The idea of applying conflicting sets is remotely reminiscent to the learning techniques with literals from SAT Modulo Theories [6, 7]. A less related document, only for rational arithmetic, is [8].

### LIST OF CITED REFERENCES

[1] M. Davis and H. Putnam, ‘A Computing Procedure for Quantification Theory’, Journal of the ACM, 7:201-215, 1960.
[2] M. Davis, G. Logemann and D. Loveland, ‘A Machine Program for Theorem-Proving’, Communications of the ACM, vol. 5, No. 7, pp. 394-397, 1962).
[3] Marques-Silva and Sakallah, ‘GRASP: A Search Algorithm for Propositional Satisfiability’, IEEE Transactions on Computers, 1063-6757, 220-227, 1996.
[4] Moskewicz, et. al. ‘Chaff: Engineering an Efficient SAT Solver”, Jun. 18-22, 2001 DAC 2001 pp. 530-535.
[5] Jovanovic de Moura, ‘Cutting to the Chase—Solving Linear Integer Arithmetic”, J. Autom. Reasoning 51(1): 79-108 (2013).
[6] Nieuwenhuis et. al. ‘Solving SAT and SAT Modulo Theories: From an Abstract Davis-Putnam-Logemann-Loveland Procedure to DPLL(T)’, Journal of the ACM, 53(6), 937-977, 2006.
[7] Moura and Bjorner, ‘Satisfiability Modulo Theories: Introduction and Applications”: Commun. ACM 54(9): 69-77 (2011).
[8] Korovin and Voronkov, ‘Solving Systems of Linear Inequalities by Bound Propagation’, CADE 2011: 369-383.
[9] Robert Nieuwenhuis, ‘The IntSat Method for Integer Linear Programming’, Springer International Publishing, LNCS 8656, pp. 574-589, 2014.

### SUMMARY OF THE INVENTION

The invention proposes a computer-implemented method for solving sets S of linear arithmetic constraints modelling physical systems for deciding whether a given IP has any solution, and in the positive case finding one or more solutions. The invention comprises a number of data structures and algorithms, based on bound propagation and cuts that make a backtracking-based search procedure efficient and useful.

In a characteristic manner, the computer-implemented method automatically performs the following steps using a processor unit:
1a) feeding the set of linear arithmetic constraints S to the processor unit;
1b) creating a standard stack data structure B that is initially empty; said data structure containing a set of bounds and supporting the standard stack operations; said stack data structure B is stored in the processor and is being modified by considering the set of linear arithmetic constraints S by the subsequent steps;
1c) if there is a linear arithmetic constraint C in S and a set of bounds R in B such that C and R propagate a bound b that is new in B, then pushing b on top of the stack B, and associating to b the set R as its reason set and the linear constraint C as its reason constraint; and iterating this pushing and associating while possible;
1d) treating four non-overlapping cases:
   1d1) if there is no conflicting pair of bounds in B and if, for all i in {i . . . n} the variable xᵢ is defined in B to a value aᵢ, then halt outputting the solution Sol such that Sol(xᵢ)=aᵢ for each i in i . . . n;
   1d2) if there is no conflicting pair of bounds in B and at least one variable is not defined in B, then a bound d is pushed on top of B such that d is new in B and d is not conflicting with any other bound in B, said bound d being called a decision;
   1d3) if there is at least one conflicting pair of bounds b₁ and b₂ in B such that there is no decision in B below b, nor below b₂ then halt outputting “no solution”;
   1d4) if there is at least one conflicting pair of bounds b₁ and b₂ in B such that there is at least one decision located in B below b₁ or below b₂ then perform a conflict analysis based on the current stack B and as a consequence of which firstly a number of topmost elements of the stack B are popped and after that a new bound with an associated reason set and reason constraint is pushed on top of the stack and a new linear constraint is learned;
1e) return to step 1c).

In accordance with one embodiment, the conflict analysis further uses following two data structures:
a Conflicting Subset and
a Conflicting Constraint,
   and the proposed method includes the following automatic actions:
2a) if the conflicting pair of bounds is {b₁, b₂} such that b₂ is located in the stack B above b₁, then initializing the CSS to {b₁, b₂} and initializing the CC to the reason constraint of b₂;
2b) if b is the bound in the CSS that is located in the stack B closest to the top of B, then
   2b1) popping bounds from the top of stack B until there are no decisions above b in B;
   2b2) removing b from the CSS and inserting into the CSS the reason set associated with b; and
   2b3) performing a cut between the current CC and the reason constraint of b, in such a way that the variable of b is eliminated, thus obtaining a new CC; and if no such a cut exists, then the CC remains unchanged;
2c) if after popping k bounds including at least one decision from the stack B there is a set of bounds R in B such that CC and R propagate a bound b that is new in B, then popping k bounds from the stack B and pushing b on top of B with associated reason set R and reason constraint CC, and halting the conflict analysis;
2d) if the CSS contains more than one bound that is located in B up or above the topmost decision of B then going to step 2b);
2e) if the CSS contains exactly one bound b that is located in B up or above the topmost decision of B, then:
   2e1) if the CSS contains b as its unique element, then popping bounds from the stack B until B contains no decisions and after that pushing on the stack a new bound being the negation of b with an associated empty reason set and the final CC as its reason constraint; then this CC is learned,
   2e2) if the CSS contains more than one bound, then if b₁ is the bound of the CSS different from b such that b₁ is located in the stack B closest to the top of B, above exactly k decisions, then popping bounds from the stack B until B contains exactly k decisions and after that pushing on the stack a new bound being the negation of b, having this new bound as its associated reason set the result of removing b from the CSS, and the final CC as its reason constraint, and then learning this CC.

The step 2c) is optional and can be omitted.

To be noted that, in particular, the first time step 2b) is performed no such a cut exists since in that case CC and the reason constraint of b are the same linear constraint.

In one embodiment in step 2d), even if the CSS contains zero or one bound located in B up or above the topmost decision of B, then also going to step 2b).

In another embodiment after each application of step 2b), bounds of the form a≦x are eliminated from the CSS whenever a bound a′≦x with a′>a is in the CSS and bounds of the form x≦a are eliminated from the CSS whenever a bound x≦a′ with a′<a is in the CSS.

In an alternative approach in step 2b) instead of the reason set of b, a set of bounds R is computed and inserted in the CSS, with all elements of R being located below b in B and the reason constraint of b and R also propagating b.

In an alternative approach in the step 1c) the reason set is not associated to b nor stored and in step 2b) a set of bounds R is computed and inserted in the CSS, with all elements of R being located below b in B and the reason constraint of b and R also propagating b.

In accordance with an embodiment, in step 1c) the linear arithmetic constraint C is not associated to b and in step 1d4) the conflict analysis is performed omitting steps 2b3) and 2c) involving the CC, and no new constraint is learnt.

In accordance with an embodiment, in step 1c) the iteration is performed non-exhaustively.

In accordance with an embodiment, the linear arithmetic constraints further include expressions of the form a₁x₁+ . . . +aₙxₙ≧a₀, or a₁x₁+ . . . +aₙxₙ=a₀, or a₁x₁+ . . . +aₙx>a₀, or a₁x₁+ . . . +aₙxₙ<a₀ or combinations thereof, where the coefficients a₀ . . . aₙ can be arbitrary rational numbers, sets of which are all expressible by sets S of linear constraints of the form b₁x₁+ . . . +bₙxₙ≦b₀, with integer coefficients b₀ . . . bₙ so that the resulting set of constraints S has the same set of solutions.

Concerning the use for optimization of the method detailed in the previous embodiment, in order to find a solution Sol that minimizes the value of a₁.Sol (x₁)+ . . . +aₙ.Sol (xₙ) for a given expression a₁x₁+ . . . +aₙxₙ, in a first iteration applying the method, and in successive iterations, while new solutions are found, applying the method with an additional constraint a₁x₁+ . . . +aₙxₙ≦a₀ where a₀ is a₁.Sol(x₁)+ . . . +a₁.Sol (xₙ)−1 where Sol is the solution found in the previous iteration.

Further in order to find a solution Sol that maximizes the value of a₁.Sol (x₁)+ . . . +aₙ·Sol (xₙ) for a given expression a₁x₁+ . . . +aₙxₙ, applying the previous embodiment minimizing −a₁x₁+ . . . +−aₙxₙ.

According to another embodiment in step 2b) instead of popping and replacing the topmost bound b from the CSS another bound is popped and replaced by its reason set.

According to another embodiment and in order to solve Mixed Integer Programs (MIPs), that is, to find a solution where a given subset I of the variables must take integer values and the remaining variables can take arbitrary rational values, it is proposed to use an arbitrary LP solver for finding a solution RSol minimizing the value of an expression a₁x₁+ . . . +aₙxₙ, where in RSol all variables are allowed to take rational values, outputting RSol as a solution and halting if RSol(x) is an integer for every variable x of I, and if no such a solution RSol exists, generating an infeasible subset using the LP solver and taking as CSS the subset of bounds of the infeasible subset, and taking as CC any other constraint of the infeasible subset, and continuing the conflict analysis with step 2b).

Finally, in yet another embodiment the coefficients of the linear constraints are rational or floating point numbers. In this case, in step 1 d4) the conflict analysis is performed using cuts where c and d are positive rational or floating point numbers.

### EXAMPLES

### Example 1

This example involves the embodiment without reason constraints, without cuts and without learning new constraints. In this example, and in the following one, when a bound b in the stack B has exactly k decisions at or below it in B then b is said to belong to decision level (dl) k

Consider the following two constraints:

1x+1y+3z≦5

−1x−1y≦−11

In addition, there are six one-variable constraints stating that all three variables are between −10 and 10. Note that these six constraints propagate the first six bounds with empty reason sets. Below the stack is shown (depicted here growing downwards) after propagating the initial constraints, and taking and propagating three decisions:

| bound | reason set |
|---|---|
| −10 ≦ x | { } |
| x ≦ 10 | { } |
| −10 ≦ y | { } |
| Y ≦ 10 | { } |
| −10 ≦ z | { } |
| z ≦ 10 | { } |
| 1 ≦ x | {y ≦ 10} |
| 1 ≦ y | {x ≦ 10} |
| z ≦ 1 | {1 ≦ x, 1 ≦ y} |
| 7 ≦ y | decision |
| z ≦ −1 | {1 ≦ x, 7 ≦ y} |
| x ≦ 5 | decision |
| −1 ≦ z | decision |
| x ≦ 1 | {7 ≦ y, −1 ≦ z} |
| 10 ≦ y | {x ≦ 1} |
| x ≦ −2 | {10 ≦ y, −1 ≦ z} |

Now there is a conflict with initial CSS {1≦x, x≦−2}.

In the first conflict analysis step, x≦−2 is removed from the CSS and its reason set {10≦y, −1≦z}, inserted obtaining {1≦x, −1≦z, 10≦y}. Since this CSS contains more than one bound of the highest decision level (dl 3), 10≦y is also replaced by its reason, getting {1≦x, −1≦z, x≦1)}. Since there are still two bounds of dl 3, x≦1 is also replaced getting {1≦x, 7≦y, −1≦z}. After this, the conflict analysis process terminates, since this final CSS contains only one bound of dl 3, which in this case is the last decision itself, −1≦z.

The negation of −1≦z is z≦−2, which is added to dl 1 (the dl of 7≦y) with reason set {1≦x, 7≦y}. Altogether, a backjump is done to:

| bound | reason set |
|---|---|
| −10 ≦ x | { } |
| x ≦ 10 | { } |
| −10 ≦ y | { } |
| y ≦ 10 | { } |
| −10 ≦ z | { } |
| z ≦ 10 | { } |
| 1 ≦ x | {y ≦ 10} |
| 1 ≦ y | {x ≦ 10} |
| z ≦ 1 | {1 ≦ x, 1 ≦ y} |
| 7 ≦ y | decision |
| z ≦ −1 | {1 ≦ x, 7 ≦ y} |
| z ≦ −2 | {1 ≦ x, 7 ≦ y} |

After one more propagation and two further decisions and their propagations, the following stack is obtained:

| bound | reason set |
|---|---|
| −10 ≦ x | { } |
| x ≦ 10 | { } |
| −10 ≦ y | { } |
| y ≦ 10 | { } |
| −10 ≦ z | { } |
| z ≦ 10 | { } |
| 1 ≦ x | {y ≦ 10} |
| 1 ≦ y | {x ≦ 10} |
| z ≦ 1 | {1 ≦ x, 1 ≦ y} |
| 7 ≦ y | decision |
| z ≦ −1 | {1 ≦ x, 7 ≦ y} |
| z ≦ −2 | {1 ≦ x, 7 ≦ y} |
| −2 ≦ z | decision |
| x ≦ 4 | {7 ≦ y, −2 ≦ z} |
| 4 ≦ x | decision |
| y ≦ 7 | {4 ≦ x, −2 ≦ z} |
| z ≦ −2 | {4 ≦ x, 7 ≦ y} |

It gives the solution where x=4, y=7 and z=−2, since all variables are fully defined to these values.

### Example 2

Consider the following three constraints:

C₀:+1x−3y−3z≦1

C₁:−2x+3y+2z≦−2

C₂:+3x−3y+2z≦−1

and the stack (depicted here growing downwards) with some initial bounds coming from one-variable constraints, and taking and propagating two decisions:

| bound | reason set | reason constraint |
|---|---|---|
| −2 ≦ x | { } | |
| x ≦ 3 | { } | |
| 1 ≦ y | { } | |
| y ≦ 4 | { } | |
| −2 ≦ z | { } | |
| z ≦ 2 | { } | |
| 1 ≦ x | {1 ≦ y, −2 ≦ z} | C₁ |
| y ≦ 2 | {x ≦ 3, −2 ≦ z} | C₁ |
| z ≦ 0 | {x ≦ 3, 1 ≦ y} | C₁ |
| x ≦ 2 | decision | |
| z ≦ −1 | {x ≦ 2, 1 ≦ y} | C₁ |
| z ≦ −2 | decision | |
| x ≦ 1 | {y ≦ 2, z ≦ −2} | C₀ |
| 2 ≦ y | {1 ≦ x, z ≦ −2} | C₀ |
| 2 ≦ x | {2 ≦ y, −2 ≦ z} | C₁ |

Now there is a conflict with initial CSS {x≦1, 2≦x}. In the first conflict analysis step, 2≦x is removed from the CSS and its reason set {2≦y, −2≦z} inserted, obtaining the CSS {−2≦z, x≦1, 2≦y}, with two bounds of this decision level (dl 2).

In the second conflict analysis step, 2≦y is replaced by its reason set {1≦x, z≦−2} obtaining the new CSS {−2≦z, 1≦x, z≦−2, x≦1} which does not allow yet to backjump since it still contains two bounds of dl 2. But now a cut is attempted between the initial CC, which is C₁, and the reason constraint of 2≦y, which is C₀, in such a way that y is eliminated. Here this cut exists, with c=d=1, and the new constraint C₃:

−1x−1z≦−1 is obtained and learned. This new constraint allows one to backjump to dl 1, since there it propagates 2≦x. At that point, after three more propagations,

| bound | reason set | reason constraint |
|---|---|---|
| −2 ≦ x | { } | |
| x ≦ 3 | { } | |
| 1 ≦ y | { } | |
| y ≦ 4 | { } | |
| −2 ≦ z | { } | |
| z ≦ 2 | { } | |
| 1 ≦ x | {1 ≦ y, −2 ≦ z} | C₁ |
| y ≦ 2 | {x ≦ 3, −2 ≦ z} | C₁ |
| z ≦ 0 | {x ≦ 3, 1 ≦ y} | C₁ |
| x ≦ 2 | decision | |
| z ≦ −1 | {x ≦ 2, 1 ≦ y} | C₁ |
| 2 ≦ x | {z ≦ −1} | C₃ |
| −1 ≦ z | {x ≦ 2} | C₃ |
| 2 ≦ y | {2 ≦ x, z ≦ −1} | C₀ |
| 2 ≦ x | {2 ≦ y, −1 ≦ z} | C₁ |

another conflict exists with CSS {x≦2, 3≦x}, which after the first step becomes {x≦2, −1≦z, 2≦y}, all three of this decision level (dl 1). After the second step (replacing 2≦y) the CSS becomes {x≦2, z≦−1, 2≦x, −1≦z}, all in dl 1. As before, the performed cut between C₁ and C₀ (the initial CC and the reason constraint of 2≦y) eliminates the variable y, obtaining −1x−1z≦−1.

After the third step (replacing −1≦z), the CSS becomes {x≦2, z≦−1, 2≦x}, all in dl 1. The CC does not change because no cut eliminating z exists with C₃.

After the 4th step (replacing 2≦x), the CSS becomes {x≦2, z≦−1}, both in dl 1. Again the CC does not change because no cut eliminating z exists with C₃.

After the 5th step (replacing z≦−1), the CSS becomes {1≦y, x≦2}, with only one literal of dl 1. The backjump with this CSS can take us to the dl of 1≦y (dl 0) and add there the negation of x≦2, which is 3≦x.

The result of the cut on CC with C₁ eliminating z gives us −4x+3 y≦−4. The backjump with this cut can also take us to the dl of 1≦y (dl 0), propagating 2≦x. Since this is weaker than the bound 3≦x obtained from the CSS, here the CSS one has been chosen. After two more propagations, the procedure returns ‘no solution’ since the conflicting pair of literals y≦2 and 3≦y appear at dl 0:

| bound | reason set | reason constraint |
|---|---|---|
| −2 ≦ x | { } | |
| x ≦ 3 | { } | |
| 1 ≦ y | { } | |
| y ≦ 4 | { } | |
| −2 ≦ z | { } | |
| z ≦ 2 | { } | |
| 1 ≦ x | {1 ≦ y, −2 ≦ z} | C₁ |
| y ≦ 2 | {x ≦ 3, −2 ≦ z} | C₁ |
| z ≦ 0 | {x ≦ 3, 1 ≦ y} | C₁ |
| 3 ≦ x | {1 ≦ y} | C₄ |
| −1 ≦ z | {3 ≦ x, y ≦ 2} | C₀ |
| 3 ≦ y | {3 ≦ x, −1 ≦ z} | C₀ |

### Data Structures and Algorithms

The method proposed in this invention heavily relies on the efficiency of its implementation, for which new data structures and algorithms are given.

There is an array, the Bounds Array, indexed by variable number, that can return in constant time the current upper and lower bounds for that variable. Property 1: It always stores, for each variable xᵢ, the positions plᵢ and puᵢ in the stack of its current (strongest) upper bound and lower bound, respectively, with plᵢ=0 (puᵢ=0) if x, has no current lower (upper) bound.

The data structure for the stack is another array containing at each position three data fields: a bound, a natural number pos, and an info field containing, among other information, the reason set and the reason constraint. Property 2: The value pos is always the position in the stack of the previous bound of the same type (lower or upper) for this variable, with pos=0 for initial bounds.

When pushing a new bound on the stack, and when popping a bound from the stack (during backjumping), it is easy to maintain properties 1 and 2 in constant time.

TABLE 1
Bounds array

Height in stack of
current bound

| | Lower: | upper |
|---|---|---|
| x₁ | 1 | 2 |
| x₂ | 0 | 0 |
| | . | . |
| | . | . |
| | . | . |
| x₇ | 40 | 31 |
| | . | . |
| | . | . |
| | . | . |

TABLE 2
Stack

| | | | |
|---|---|---|---|
| 1 | 0 ≦ x₁ | 0 | info |
| 2 | x₁ ≦ 8 | 0 | info |

.
.
.

| | | | |
|---|---|---|---|
| 13 | 0 ≦ x₇ | 0 | info |
| 14 | x₇ ≦ 9 | 0 | info |

.
.
.

| | | | |
|---|---|---|---|
| 23 | 2 ≦ x₇ | 13 | info |

.
.
.

| | | | |
|---|---|---|---|
| 31 | x₇ ≦ 6 | 14 | info |

.
.
.

| | | | |
|---|---|---|---|
| 40 | 5 ≦ x₇ | 23 | info |

.
.
.

Another important data structure allows for efficient bound propagation. For each variable x, there are two occurs lists. The positive occurs list for x contains all pairs (I_{C}, a) s.t. C is a linear constraint where x occurs with positive coefficient a. The negative occurs list contains the same for occurrences with a negative coefficient a. Here I_{C} is an index to the constraint header of C in the array of constraint headers. Each constraint header contains an integer F_{C} called a filter, and a (pointer to) the constraint C itself. The filter F_{C} is maintained cheaply, in such a way that C can only propagate if F_{C}>0, thus avoiding many useless (cache-) expensive inspections of the actual constraint C. This is done as follows.

Let C be a constraint of the form a₁x₁+ . . . +aₙxₙ≦a₀. Let lᵢ≦xᵢ and xᵢ≦uᵢ be the current lower and upper bounds (if any) for xᵢ. Each expression aᵢxᵢ in C can have a minimal value mᵢ, which is aᵢ·lᵢ if aᵢ>=0, and aᵢ·uᵢ otherwise.

Here mᵢ is undefined if there is no such bound lᵢ (or uᵢ). Initially, if some mᵢ is undefined, then F_{C} is set to a special value undefined and otherwise to −a₀+m₁+ . . . +mₙ+maxᵢ, {abs(aᵢ·(uᵢ-lᵢ))} where max and abs denote the maximum and absolute value functions, respectively. After that, F_{C} is said to be precise: the constraint C propagates if and only if, undefined≠F_{C}>0. Property 3: At all timepoints, F_{C}=undefined or F_{C} is an upper approximation of the precise one.

To preserve property 3, these filters need to be updated when new bounds are pushed onto the stack, and need to be restored when backjumping.

Let a new lower bound k≦x be pushed onto the stack. Let the previous lower bound for x (if any) be k′≦x. For each pair (I_{C}, a) in the positive occurs list of x, using I_{C}, access is done to the F_{C} and increase it by abs (a·(k−k′)). If there was no previous lower bound, then F_{C} was undefined and is now set to 1. If F_{C} becomes positive, the constraint C is visited because it may propagate some new bound. After each time a constraint C is visited, F_{C} is set to its precise value.

Let a new upper bound x≦k be pushed on the stack. Then exactly the same is done, where x≦k′ is the previous upper bound for x (if any), and using the negative occurs list. In order to be able to restore the filters when backjumping, each time an F_{C} value is increased by an amount d, a pair (F_{C}, d) is pushed onto a filter backtrack stack, and when it is moved from undefined to 1 a pair (F_{C}, undefined) is pushed.

For each decision that is taken, i.e., when pushing the i+1th decision on the stack, in a separate data structure a natural number hᵢ is recorded, hᵢ being the height of the filter backtrack stack before taking decision i+1. Then, when backjumping to a stack with k decisions, each pair (F_{C}, d) in the filter backtrack stack above height hₖ is popped, and its F_{C} is decreased by d if d≠undefined, and restored to undefined if d=undefined.

Following a particular application case in which the proposed method is applied will be explained.

A steel factory needs to plan its next week, 168 hours in which it has to carry out N tasks (orders).

Each task i in 1 . . . N has a duration of dᵢ consecutive (whole) hours and requires, during all its dᵢ hours of activity, the exclusive use of one or more units of R different resources. For example, a certain task may occupy two mechanics, one operator, three cranes and two trucks. If during a certain hour several tasks are active simultaneously, they cannot share the resources they use.

For each resource j and each hour h in 1 . . . 168, let the integer used_{j,h} denote the total number of units of resource j used during hour h and let peakⱼ=max(used_{j,1}, . . . used_{j,168}) be the (integer) peak usage of resource j during the week. The problem is to schedule all tasks, i.e., for each task i determine a starting time, while minimizing the total resource cost C=c₁·peak_{—1}≦, + . . . +c_{R}·peak_{R}, where each cⱼ is a cost associated to resource j.

In practice the planned period of course needs not be 168 time units, and typically there are many more constraints, usually involving logical relationships, such as precedences between (groups of) tasks, temporary unavailability of resources, earliest or latest starting times for tasks, storage capacities for intermediate products, etc.

This problem is well known to have a large impact on costs and benefits in industry. Finding good solutions can be extremely hard.

A standard notation for it uses two sets of N·168 binary variables starts_{i,h} (“task i starts on hour h”) and isactive_{i,h} (“task i is active on hour h”) for all i and h.

It uses constraints expressing that starts_{i,h} implies isactive_{i,h} (i.e., −starts_{i,h}+isactive_{i,h}≧0) and also starts_{i,h} implies isactive_{i,h+1}, etc., for its whole duration dᵢ. Also, each task i starts exactly once: starts_{i,1}+ . . . +starts_{i,168}=1. In addition, for each resource j and hour h, we have used_{j,h}=units_needed_{1,j}·isactive_{1,h}+ . . . +units_needed_{N,j}−isactive_{N,h}, where units_needed_{i,j} is the number of units of j needed by task i. Finally, for each resource j there are 168 constraints peakⱼ≧used_{j,1} . . . peakⱼ≧used_{j,168}.

A state-of-the-art methodology is the one used in MIP solvers, by solving a collection of LP relaxations of the given constraints, i.e., temporarily “forgetting” that certain variables must take integer values. Rational (possibly non-integer) solutions are sought for by means of (variants of) simplex or interior point methods. Such “forgetful” or “blind” intermediate non-integer solutions may be meaningless for our problem, since they may say, e.g., that a certain binary variable active_{i,h} is 0.7, or that 3.54 units of resource j are used during some hour h.

Additional steps are then performed to turn these intermediate solutions into an integer one. For example, branch-and-cut methods maintain a tree of subproblems pending to be explored, with their rational solutions. Given a leaf node with variable x getting a non-integer solution 3.54, one can branch, i.e., split the problem into two subproblems, one with x≦3 and one with x≧4, or compute and add a new constraint (by a cut), precluding the non-integer solution 3.54 for x.

Such MIP solvers are well known to perform extremely poorly on pure SAT problems, where all variables are binary and constraints are (purely logical) clauses, and where conflict-driven clause-learning (CDCL) techniques are vastly superior and hence the method of choice in practice.

Here it is claimed a similar superiority of this invention, also a SAT-like method, for this industrial scheduling problem, which also has many binary variables and other relatively small-domain integer ones, as well as an essentially logical constraint structure as in pure SAT.

The proposed method explores the search space as CDCL does in SAT: by taking decisions (in our case each decision, as stated in step 1d2, is a heuristically guided guess of an upper or lower bound for a given variable) and efficiently inferring and adding the implied information by propagating these decisions. And, again as in CDCL, when a conflict appears (i.e., two contradictory bounds), a conflict analysis procedure allows one to backjump to an earlier search state, enrich it by an additional bound and its propagations, and possibly learning a new constraint.

Together with [5], the proposed method is the first of this nature able to handle integer variables and constraints, but with the advantage over [5] that in the proposed method arbitrary decisions can be taken. Indeed it performs much better than [5], as revealed by the experiments of the publication [9] (which also reports superiority over the main commercial MIP solvers on other ILP problems from the well-known standard MIPLIB).

As it happens in methods for SAT (cf. section “Background of the invention”), it is rather obvious that the proposed method performs a systematic search over the possible solutions. This involves only trivial mathematics. Again as for SAT, the key aspects of the proposed method are the engineering of novel data structures (propagation record, propagation stack, reason set, reason constraint) and the novel heuristics for guiding the search and for learning new constraints. Such techniques for SAT are disclosed in U.S. Pat. No. 7,418,369.

Applied to the industrial scheduling problem, the proposed method uses heuristics for taking good decisions (typically, as in SAT, on variables involved in many recent conflicts). For example, it will guess an upper bound on the total resource cost C or on some of the individual variables peakₕ. Meaningful new bounds will then be propagated (unlike what happens in LP relaxations; present propagation takes into account that variables must be integer). Similarly, meaningful strong new constraints are quickly learned, stating that certain combinations of tasks cannot take place simultaneously, etc.

These newly learned constraints again strengthen the propagation power and prevent future similar conflicts.

Being able to take arbitrary decisions is essential (step 1d2 of claim 1) to the proposed method. In [5] one can only decide a given variable to be equal to its current upper bound or to its current lower bound; in practice, one needs to guess it to belong to, say, the lower (or upper) halve of the interval between its current upper and lower bounds, an idea akin to binary search.

While preferred embodiments of the invention have been shown and described herein, it will be understood that such embodiments are provided by way of example only. Numerous variations, changes and substitutions will occur to those skilled in the art without departing from the spirit of the invention. Accordingly, it is intended that the appended claims cover all such variations as fall within the spirit and scope of the invention.

1. A computer-implemented method for solving sets of linear arithmetic constraints modelling physical systems, the method comprising using a computer processor unit performing a programmed execution of mathematical operations wherein, being {x₁ . . . xₙ} a set of variables, said linear arithmetic constraints are expressions of the form a₁x₁+ . . . +aₙxₙ≦a₀, in which the coefficients a₀ . . . aₙ are integer numbers,
wherein a solution for a set of linear arithmetic constraints S is an expression Sol mapping each variable x of {x₁ . . . xₙ} to an integer value Sol(x) such that all constraints are satisfied, that is, for each constraint of the form a₁x₁+ . . . +aₙxₙ≦a₀ in S, the integer number a₁.Sol(x₁)+ . . . +aₙ·Sol(xₙ) is smaller than or equal to a₀;
wherein the following notions/terms are used:
bound (constraint with a single variable x, that can be written as lower bounds a≦x or upper bounds x≦a) where a is an integer number
the negation of a lower bound a≦x is the upper bound x≦a−1 and the negation of an upper bound x≦a is the lower bound a+1≦x;
a lower bound a₁≦x and an upper bound x≦a₂ are called conflicting if a₁>a₂;
a lower bound a≦x is called new in a given set of bounds B if there is no lower bound a′≦x in B with a′≧a, and an upper bound x≦a is called new in a given set of bounds B if there is no upper bound x≦a′ in B with a′≦a, and a variable x is called defined to the value a in a given set of bounds B, if B contains the bounds a≦x, and x≦a; and
a monomial is an expression of the form a x, where a is an integer or a rational number and x is a variable; it called negative if a is negative and positive otherwise;
propagation:
If C is a linear arithmetic constraint of the form a₁x₁+ . . . +aₙxₙ≦a₀ where:
the subset of positive monomials of {a₁x₁+ . . . +aₙxₙ} is {ax, c₁y₁, . . . , cₚyₚ};
the subset of negative monomials of {a₁x₁+ . . . +aₙxₙ} is {d₁z₁, . . . , d_{q}z_{q}};
R is a set of bounds {l₁≦y₁, . . . , lₚ≦yₚ, z₁≦u₁, . . . , z_{q}≦u_{q}};
u is the largest integer such that u≦(a₀−c₁l₁− . . . −cₚlₚ−d₁u₁− . . . −d_{q}u_{q})/a, then C and R propagate the upper bound x≦u;
If C is a linear arithmetic constraint of the form a₁x₁+ . . . +aₙxₙ≦a₀ where:
the subset of positive monomials of a₁x₁+ . . . +aₙxₙ is {c₁y₁, . . . , cₚyₚ};
the subset of negative monomials of a₁x₁+ . . . +aₙxₙ is {ax, d₁z₁, . . . , d_{q}z_{q}};
R is a set of bounds {l₁≦y₁, . . . , lₚ≦yₚ, z₁≦u₁, . . . , z_{q}≦u_{q}};
l is the smallest integer such that l≧(a₀−c₁l₁− . . . −cₚlₚ−d₁u₁− . . . −d_{q}u_{q})/a, then C and R propagate the lower bound l≦x,
a propagation record is a triple (b, R, C) where b is a bound C is a linear arithmetic constraint and R is a set of bounds such that C and R propagate b, then R being termed the reason set of b and C being termed the reason constraint of b; in a special kind of propagation record called a decision, the components R and C are null,
a propagation stack is a data structure having capabilities of a standard stack data structure whose elements are propagation records, with standard operations for pushing and popping elements and for inspecting the topmost element and in addition the nonstandard capability of inspecting non-topmost elements;
a bound b is said to be in a propagation stack B if b is the first element of some propagation record of B; similarly a set of bounds R is said to be in a propagation stack B if R is a subset of the set of all first elements of the propagation records of B,
a constraint C is said to be learned when it is added to the set of linear arithmetic constraints S;
wherein said programmed execution of mathematical operations of the method being automatically performed, by the following steps:
1a) receiving by the computer processor unit the set of linear arithmetic constraints S;
1b) creating using the computer processor unit a propagation stack B that is initially empty; being said propagation stack B stored in the computer processor unit and being automatically modified using the computer processor unit by considering the set of linear arithmetic constraints S by implementing the subsequent steps;
1c) if there is a linear arithmetic constraint C in S and a set of bounds R in B such that C and R propagate a bound b that is new in B, then pushing the propagation record (b, R, C) on top of the stack B; and iterating this pushing while possible;
1d) treating four non-overlapping cases using the computer processor unit:
1d1) if there is no conflicting pair of bounds in B and if, for all i in {i . . . n} the variable xᵢ is defined in B to a value aᵢ, then halt outputting the solution Sol such that Sol(xᵢ)=aᵢ for each i in i . . . n;
1d2) if there is no conflicting pair of bounds in B and at least one variable is not defined in B, then a propagation record (d, −, −) is pushed on top of B such that d is new in B and d is not conflicting with any other bound in B, said bound d and the propagation record (d, −, −) being termed a decision, and then return to step 1c);
1d3) if there is at least one conflicting pair of bounds b₁ and b₂ in B such that there is no decision in B below b₁ nor below b₂ then halt outputting “no solution”;
1d4) if there is at least one conflicting pair of bounds b₁ and b₂ in B such that there is at least one decision located in B below b₁ or below b₂ then a conflict analysis is performed based on the current propagation stack B and as a consequence of which firstly a number of topmost elements of the propagation stack B are popped and after that a new bound with an associated reason set and reason constraint is pushed on top of the stack and a new linear constraint C is learned, and then return to step 1c).

2. The method of claim 1 wherein said conflict analysis further uses a data structure called the CSS, Conflicting Subset, a set data structure storing a subset of the bounds of B, and another data structure called the CC, Conflicting Constraint, wherein the following notions are used:
if C₁ is a linear arithmetic constraint a₁x₁+ . . . +aₙxₙ≦a₀, and C₂ is a linear arithmetic constraint b₁x₁+ . . . +bₙxₙ≦b₀, then a cut between C₁ and C₂ is a linear arithmetic constraint c₁x₁+ . . . +cₙxₙ≦c₀ such that c and d are positive natural numbers and cᵢ=c·aᵢ+d·bᵢ for each i in 0 . . . n; and
if cⱼ=0 for some j in 1 . . . n then this cut is said to eliminate the variable xⱼ, the method comprising the following steps:
2a) if the conflicting pair of bounds is {b₁, b₂} such that b₂ is located in the stack B above b₁, then initializing the CSS to {b₁, b₂} and initializing the CC to the reason constraint of b₂;
2b) if b is the bound in the CSS that is located in the stack B closest to the top of B, then
2b1) popping bounds from the top of stack B until there are no decisions above b in B;
2b2) removing b from the CSS and inserting into the CSS the reason set associated with b;
2b3) performing a cut between the current CC and the reason constraint of b, in such a way that the variable of b is eliminated, thus obtaining a new CC; and if no such a cut exists, then the CC remains unchanged;
2c) if after popping k bounds including at least one decision from the stack B there is a set of bounds R in B such that CC and R propagate a bound b that is new in B, then popping k bounds from the stack B and pushing b on top of B with associated reason set R and reason constraint CC, and halting the conflict analysis;
2d) if the CSS contains more than one bound that is located in B at the height of the topmost decision of B or above then going to step 2b);
2e) if the CSS contains exactly one bound b that is located in B at the height of the topmost decision of B or above:
2e1) if the CSS contains b as its unique element, then popping bounds from the stack B until B contains no decisions and after that pushing on the stack a new bound being the negation of b with an associated empty reason set and the final CC as its reason constraint; then this CC is learned, and
2e2) if the CSS contains more than one bound, then if b₁ is the bound of the CSS different from b such that b₁ is located in the stack B closest to the top of B, above exactly k decisions, then popping bounds from the stack B until B contains exactly k decisions and after that pushing on the stack a new bound being the negation of b, having this new bound as its associated reason set the result of removing b from the CSS, and the final CC as its reason constraint, and then learning this CC.

3. The method of claim 1 wherein said conflict analysis further uses a data structure called the CSS, Conflicting Subset, a set data structure storing a subset of the bounds of B, and another data structure called the CC, Conflicting Constraint, wherein the following notions are used:
if C₁ is a linear arithmetic constraint a₁x₁+ . . . +aₙxₙ≦a₀, and C₂ is a linear arithmetic constraint b₁x₁+ . . . +bₙxₙ≦b₀, then a cut between C₁ and C₂ is a linear arithmetic constraint c₁x₁+ . . . +cₙxₙ≦c₀ such that c and d are positive natural numbers and cᵢ=c·aᵢ+d·bᵢ for each i in 0 . . . n; and
if cⱼ=0 for some j in 1 . . . n then this cut is said to eliminate the variable xⱼ, the method comprising the following steps:
3a) if the conflicting pair of bounds is {b₁, b₂} such that b₂ is located in the stack B above b₁, then initializing the CSS to {b₁, b₂} and initializing the CC to the reason constraint of b₂;
3b) if b is the bound in the CSS that is located in the stack B closest to the top of B, then
3b1) popping bounds from the top of stack B until there are no decisions above b in B;
3b2) removing b from the CSS and inserting into the CSS the reason set associated with b;
3b3) performing a cut between the current CC and the reason constraint of b, in such a way that the variable of b is eliminated, thus obtaining a new CC; and if no such a cut exists, then the CC remains unchanged;
3c) if the CSS contains more than one bound that is located in B at the height of the topmost decision of B or above then going to step 3b);
3d) if the CSS contains exactly one bound b that is located in B at the height of the topmost decision of B or above:
3d1) if the CSS contains b as its unique element, then popping bounds from the stack B until B contains no decisions and after that pushing on the stack a new bound being the negation of b with an associated empty reason set and the final CC as its reason constraint; then this CC is learned, and
3d2) if the CSS contains more than one bound, then if b₁ is the bound of the CSS different from b such that b₁ is located in the stack B closest to the top of B, above exactly k decisions, then popping bounds from the stack B until B contains exactly k decisions and after that pushing on the stack a new bound being the negation of b, having this new bound as its associated reason set the result of removing b from the CSS, and the final CC as its reason constraint, and then learning this CC.

4. The method of claim 2, wherein in step 2d), even if the CSS contains zero or one bound located in B above a decision, being the topmost decision of B, then going to step 2b).

5. The method of claim 2, wherein after each application of step 2b) bounds of the form a≦x are eliminated from the CSS whenever a bound a′≦x with a′>a is in the CSS and bounds of the form x≦a are eliminated from the CSS whenever a bound x≦a′ with a′<a is in the CSS.

6. The method of claim 2, wherein in step 2b) instead of the reason set of b, a set of bounds R is computed and inserted in the CSS, with all elements of R being located below b in B and the reason constraint of b and R also propagating b.

7. The method of claim 2 wherein in step 1c) the reason set is not associated to b nor stored and in step 2b) a set of bounds R is computed and inserted in the CSS, with all elements of R being located below b in B and the reason constraint of b and R also propagating b.

8. The method of claim 1 wherein in step 1c) the linear constraint C is not associated to b and wherein in step 1d4) the conflict analysis is performed omitting steps 2b3) and 2c) involving the CC, and no new constraint is learnt.

9. The method of claim 1 wherein in step 1c) the iteration is performed non-exhaustively.

10. The method of claim 1 wherein the linear arithmetic constraints further include expressions of the form a₁x₁+ . . . +aₙxₙ≧a₀, or a₁x₁+ . . . +aₙxₙ=a₀, or a₁x₁+ . . . +aₙxₙ>a₀, or a₁x₁+ . . . +aₙxₙ<a₀ or combinations thereof, where the coefficients a₀ . . . aₙ can be arbitrary rational numbers, sets of which are all expressible by sets S of linear constraints of the form b₁x₁+ . . . +bₙxₙ≦b₀, with integer coefficients b₀ . . . bₙ so that the resulting set of constraints S has the same set of solutions

11. The method of claim 10 further comprising in order to find a solution Sol that minimizes the value of a₁.Sol(x₁)+ . . . +aₙ·Sol(xₙ) for a given expression a₁x₁+ . . . +aₙxₙ, in a first iteration applying steps 1a) to 1e) of the method, and in successive iterations, while new solutions are found, applying steps 1a) to 1e) of the method with an additional constraint a₁x₁+ . . . +aₙxₙ≦a₀ where a₀ is a₁.Sol(x₁)+ . . . +a₁·Sol(xₙ)−1 and Sol is the solution found in the previous iteration.

12. The method of claim 10 further comprising in order to find a solution Sol that maximizes the value of a₁.Sol (x₁)+ . . . +aₙ·Sol(xₙ) for a given expression a₁x₁+ . . . +aₙxₙ, in a first iteration applying steps 1a) to 1e) of the method, and in successive iterations, while new solutions are found, applying steps 1a) to 1e) of the method with an additional constraint −a₁x₁− . . . −aₙxₙ≦a₀ where a₀ is −a₁.Sol (x₁)− . . . −aₙ·Sol (xₙ)−1 where each time Sol is the solution found in the previous iteration.

13. The method of claim 2, wherein in step 2b) instead of popping and replacing the topmost bound b from the CSS another bound is popped and replaced by its reason set.

14. The method of claim 2 wherein in order to solve Mixed Integer Programs (MIPs), that is, to find a solution where a given subset I of the variables must take integer values and the remaining variables can take arbitrary rational values, it is proposed to use an arbitrary LP solver for finding a solution RSol minimizing the value of an expression a₁x₁+ . . . +aₙxₙ, where in RSol all variables are allowed to take rational values, outputting RSol as a solution and halting if RSol(x) is an integer for every variable x of I, and if no such a solution RSol exists, generating an infeasible subset using the LP solver and starting a conflict analysis.

15. The method of claim 14, wherein to perform said conflict analysis a data structure called the CSS, Conflicting Subset, a set data structure storing a subset of the bounds of B, and another data structure called the CC, Conflicting Constraint are used, wherein the following notions are used:
if C₁ is a linear arithmetic constraint a₁x₁+ . . . +aₙxₙ≦a₀, and C₂ is a linear arithmetic constraint b₁x₁+ . . . +bₙxₙ≦b₀, then a cut between C₁ and C₂ is a linear arithmetic constraint c₁x₁+ . . . +cₙxₙ≦c₀ such that c and d are positive natural numbers and ci=c·aᵢ+d·bᵢ for each i in 0 . . . n; and
if cⱼ=0 for some j in 1 . . . n then this cut is said to eliminate the variable xⱼ, the method comprising the following steps:
15a) initializing the CSS to the subset of bounds of the infeasible subset, and initializing the CC to any other constraint of the infeasible subset;
15b) if b is the bound in the CSS that is located in the stack B closest to the top of B, then
15b1) popping bounds from the top of stack B until there are no decisions above b in B;
15b2) removing b from the CSS and inserting into the CSS the reason set associated with b;
15b3) performing a cut between the current CC and the reason constraint of b, in such a way that the variable of b is eliminated, thus obtaining a new CC; and if no such a cut exists, then the CC remains unchanged;
15c) if after popping k bounds including at least one decision from the stack B there is a set of bounds R in B such that CC and R propagate a bound b that is new in B, then popping k bounds including at least one decision from the stack B and pushing b on top of B with associated reason set R and reason constraint CC, and halting the conflict analysis;
15d) if the CSS contains more than one bound that is located in B up or above the topmost decision of B then going to step 15b);
15e) if the CSS contains exactly one bound b that is located in B up or above the topmost decision of B:
15e1) if the CSS contains b as its unique element, then popping bounds from the stack B until B contains no decisions and after that pushing on the stack a new bound being the negation of b with an associated empty reason set and the final CC as its reason constraint; then this CC is learned, and
15e2) if the CSS contains more than one bound, then if b₁ is the bound of the CSS different from b such that b₁ is located in the stack B closest to the top of B, above exactly k decisions, then popping bounds from the stack B until B contains exactly k decisions and after that pushing on the stack a new bound being the negation of b, having this new bound as its associated reason set the result of removing b from the CSS, and the final CC as its reason constraint, and then learning this CC.

16. The method of claim 14, wherein to perform said conflict analysis a data structure called the CSS, Conflicting Subset, a set data structure storing a subset of the bounds of B, and another data structure called the CC, Conflicting Constraint are used, wherein the following notions are used:
if C₁ is a linear arithmetic constraint a₁x₁+ . . . +aₙxₙ≦a₀, and C₂ is a linear arithmetic constraint b₁x₁+ . . . +bₙxₙ≦b₀, then a cut between C₁ and C₂ is a linear arithmetic constraint c₁x₁+ . . . +cₙxₙ≦c₀ such that c and d are positive natural numbers and ci=c·aᵢ+d·bᵢ; for each i in 0 . . . n; and
if cⱼ=0 for some j in 1 . . . n then this cut is said to eliminate the variable xⱼ, the method comprising the following steps:
16a) initializing the CSS to the subset of bounds of the infeasible subset, and initializing the CC to any other constraint of the infeasible subset;
16b) if b is the bound in the CSS that is located in the stack B closest to the top of B, then
16b1) popping bounds from the top of stack B until there are no decisions above b in B;
16b2) removing b from the CSS and inserting into the CSS the reason set associated with b;
16b3) performing a cut between the current CC and the reason constraint of b, in such a way that the variable of b is eliminated, thus obtaining a new CC; and if no such a cut exists, then the CC remains unchanged;
16c) if the CSS contains more than one bound that is located in B up or above the topmost decision of B then going to step 16b);
16d) if the CSS contains exactly one bound b that is located in B up or above the topmost decision of B:
16d1) if the CSS contains b as its unique element, then popping bounds from the stack B until B contains no decisions and after that pushing on the stack a new bound being the negation of b with an associated empty reason set and the final CC as its reason constraint; then this CC is learned, and
16d2) if the CSS contains more than one bound, then if b₁ is the bound of the CSS different from b such that b₁ is located in the stack B closest to the top of B, above exactly k decisions, then popping bounds from the stack B until B contains exactly k decisions and after that pushing on the stack a new bound being the negation of b, having this new bound as its associated reason set the result of removing b from the CSS, and the final CC as its reason constraint, and then learning this CC.

17. The method of claim 1 wherein the coefficients of the linear constraints are rational or floating point numbers and wherein in step 1 d4) the conflict analysis is performed using cuts where c and d are positive rational or floating point numbers.
